(19) United States
(12) Patent Application Publication
(10) Pub. No.: US 2008/0115813 A1
(43) Pub. Date: May 22, 2008

(54) Sliding Dishwasher Lid Seal

(76) Inventor: Matthew Cosgrove, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/718,305

(22) PCT Filed: Nov. 18, 2005
(86) PCT No.: PCT/NZ05/00306

§ 371 Date: Oct. 18, 2007

(30) Foreign Application Priority Data
Nov. 24, 2004 (NZ) 536816

(51) Int. Cl. B08B 3/00

(52) U.S. Cl. 134/56 D

(57) ABSTRACT

In a dishwasher of the type where an open top wash chamber (1) slides out of a cabinet (6) for loading and a closure (4) is provided in the cabinet to close the chamber during a water sealing elastomeric gasket (5) containing a magnetic material (9) and the wash chamber top edges (2) with a complementary magnetic material (10) such that when the chamber is in the washing position magnetic forces cause the flexible gasket to extend into sealing contact with the wash chamber top edges.

### FIELD OF INVENTION

This invention relates to dishwashers of the type employing a wash chamber which slides in and out of a cabinet, or from kitchen joinery, and in particular to means for sealably closing the open top of the wash chamber.

### PRIOR ART

Mechanisms for sealably closing the open top of sliding wash chambers for dishwashers are disclosed in U.S. Pat. Nos. 5,470,142; 6,189,551; and 6,571,808.

The use of electric motors to lower a lid onto the top of a wash chamber or electric pumps to inflate gaskets to form a seal between a lid and the wash chamber add to the complexity of such dishwashers and increase costs. Lids mechanically actuated by the force required to extend or retract the sliding wash chamber avoid these complexities but do not result in reliable lid seals due to the fact that the gasket must inevitably engage the rim of the wash chamber while the wash chamber is still undergoing horizontal motion either on retraction or withdrawal.

### SUMMARY OF INVENTION

It is an object of the present invention to provide a dishwasher of the type described which overcomes the abovementioned problems.

Accordingly in one aspect the invention consists in:

a dishwasher having a cabinet containing one or more wash chambers wherein at least one wash chamber has an open top and slides out of said cabinet from a washing position for loading and unloading, and a closure mounted in said cabinet which closes the top of said wash chamber during the washing process,

characterised in that a flexible gasket containing a magnetic material fitted is provided at the periphery of said closure, and the edges of said wash chamber defining said open top contain a magnetic material such that when said wash chamber is in or nearly in said washing position the magnetic force between said gasket and said chamber cause said gasket to engage in a substantially water tight seal with the top of said wash chamber.

In a second aspect the invention consists in a magnetic seal for the lid and wash chamber of a dishwasher of the type wherein one wash chamber has an open top and slides out of said cabinet from a washing position for loading and unloading and a closure mounted in said cabinet which closes the top of said wash chamber during the washing process, the improvement comprising:

a flexible gasket formed from a low friction material and containing a magnetic material fitted to said closure which when said wash chamber is in or nearly in the washing position is attracted by magnetic force to engage in a substantially water tight seal with the top of said wash chamber.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

FIG. 1 shows a dishwasher of the type to which the present invention applies;

FIG. 2 shows a diagrammatic vertical longitudinal section of a dishwasher with fixed rigid lid and single wash chamber;

FIG. 3 shows diagrammatically a sealing arrangement for the FIG. 2 embodiment employing a magnetic gasket (at the side of the wash chamber);

FIG. 4 shows one implementation of the sealing arrangement of FIG. 1 at the side of the wash chamber of FIG. 3;

FIG. 5 shows a diagrammatic vertical longitudinal section of a floating rigid lid alternative to FIG. 2 employing a magnetic gasket with the wash chamber withdrawn;

FIG. 6 shows the FIG. 5 embodiment with the wash chamber retracted;

FIG. 7 shows an interior view of a portion of the lid and wash chamber for the FIG. 5 embodiment;

FIG. 8 shows a sealing arrangement for the FIG. 5 embodiment of the front of the wash chamber;

FIG. 9 shows a sealing arrangement for the FIG. 5 embodiment of the back of the wash chamber;

FIG. 10 shows a diagrammatic vertical longitudinal section of a fixed rigid lid with a moveable magnetic gasket with the wash chamber withdrawn;

FIG. 11 shows the FIG. 9 embodiment with the wash chamber retracted;

FIG. 12 shows an alternative form of magnetic gasket for a fixed rigid lid dishwasher; and

FIG. 13 shows diagrammatically a further embodiment where a further set of magnets are incorporated in the dishwasher cabinet above the lid to provide a force to break the gasket seal during withdrawal of the tub from the cabinet.

### DESCRIPTION OF THE PREFERRED EMBODIMENTS

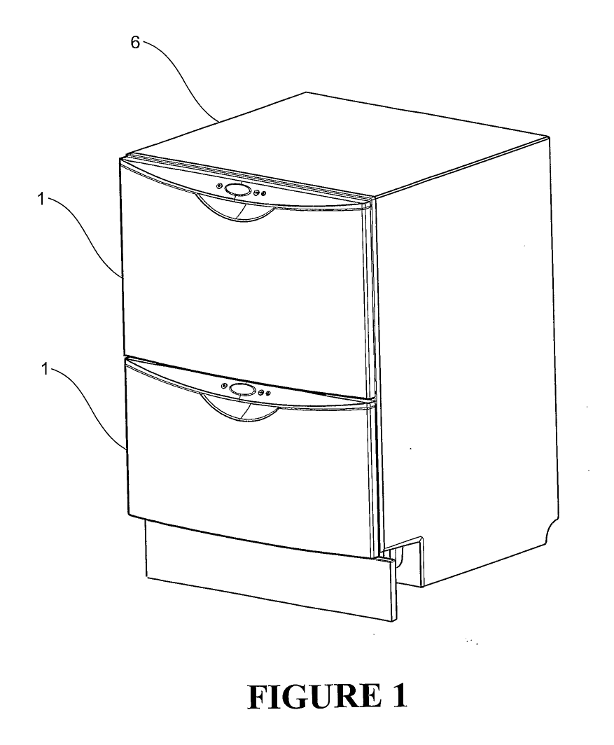

The type of dishwasher to which the present invention is applicable is shown in FIG. 1. One or two slideable wash chambers 1 are mounted in a cabinet 6, each wash chamber having its own complete and independent wash system. The wash chambers are slid out of the cabinet for top loading and washing operations in a chambers is initiated when that chamber is retracted into a washing position within the cabinet and its open top sealed by a lid or other closure device which is mounted within the dishwasher cabinet and remains in the cabinet upon withdrawal of the wash chamber. The present invention is concerned with the manner in which such “lids” or “closures” form a watertight seal with the wash chamber rim.

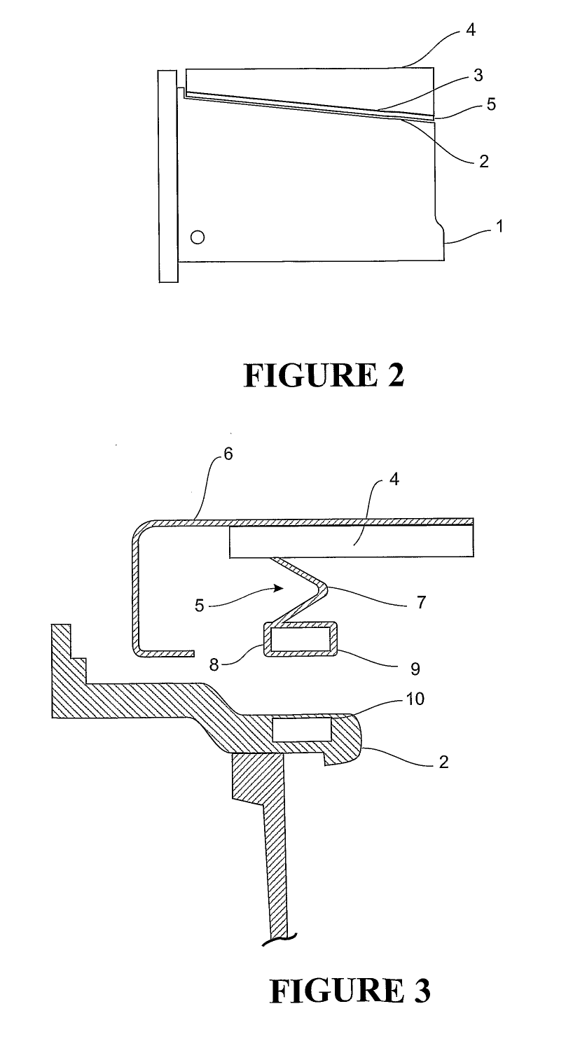

A first embodiment of the invention will be described with reference to FIGS. 2 to 4. In this embodiment the dishwasher lid and chamber rim have a wedge shaped configuration as shown in FIG. 1. When chamber 1 is fully retracted into the dishwasher cabinet in the position illustrated (the “washing position”) the chamber rim 2 almost touches the sealing edges 3 of lid 4. The vertical spacing between rim 2 and edge 3 is then sufficiently small to allow the sealing device 5 to form a water tight seal in a manner which will now be described with reference to FIG. 3.

Lid 4 is mounted within cabinet 6 in a fixed horizontal and vertical position. The periphery of lid 4 carries a gasket indicated generally as 5. This comprises a compliant elastomeric web section 7 which retains an abutment section 8 which in one form is moulded about an iron insert 9. Abutment member 8 is intended to abut against wash chamber rim 2 when the chamber is fully retracted in cabinet 6. Wash chamber rim 2 contains a magnet member 10 which extends continuously around the periphery of the rim and which is embedded in the rim by moulding or some alternate insertion method. When the wash chamber is almost fully retracted the magnet 10 attracts iron insert 9 downwards which causes the gasket 5 to engage with rim 2 with the final portion of travel of the wash chamber being conducted with the gasket sliding over the rim.

The material used for abutment member 8 must have the appropriate properties to allow a sliding contact with chamber rim 2 with minimal wear over the lifetime of the dishwasher. Any wear will ultimately result in leakage of water from the wash chamber during washing operations. One preferred material is PTFE which may either be in tape form adhered to the lower surface of the abutment member or alternatively co-moulded onto the lower surface of the abutment member. The material used for the sealing device web and abutment member can be any suitable compliant elastomeric material which is mouldable or extrudable.

Instead of using an iron insert in abutment member 8 a magnet could be inserted here with an iron insert placed in the wash chamber rim. As a further alternative it would be possible to use electromagnets on both sides which has the advantage that when the wash chamber is to be withdrawn from the cabinet a repellent force could be produced to release sealing device 5 from the wash chamber rim.

Where electromagnets with repel mode are not used, then on withdrawal of the wash chamber from the cabinet the chamber rim 2 slides against the sealing device 5 with the complementary wedge shape of lid 4 and wash chamber rim increasing the vertical spacing therebetween as the drawer moves horizontally. At a certain point the vertical spacing is such that the restoring force of the sealing device 5 exceeds the magnetic attraction force and the sealing device snaps away from the chamber rim.

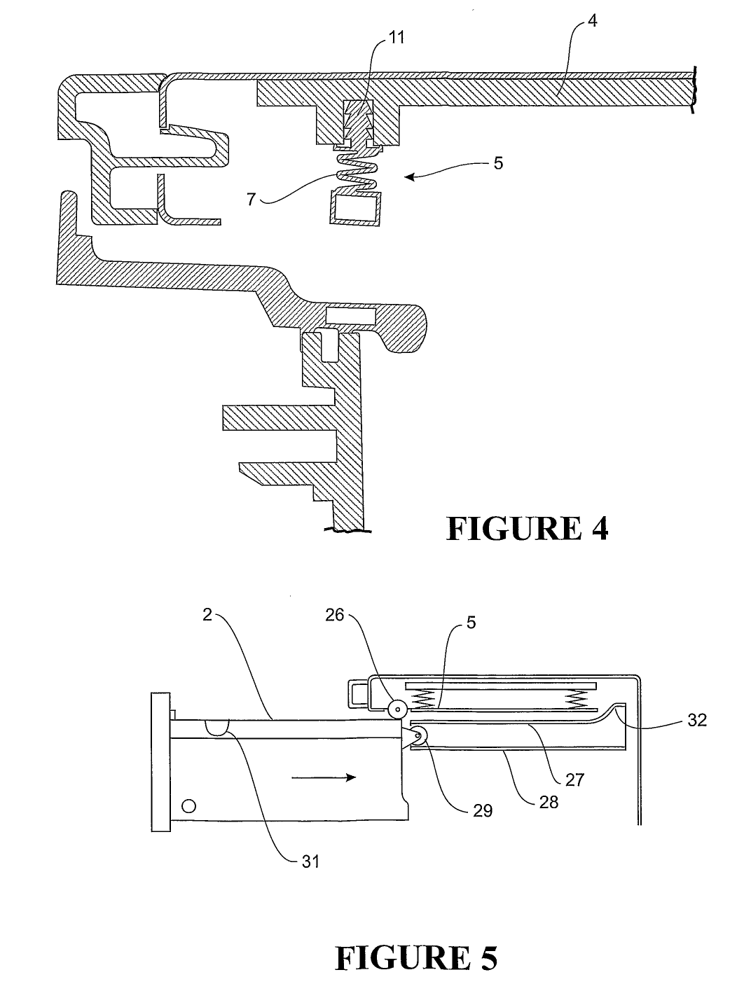

The need for a low friction slip coat is not only to reduce wear with usage, but also to reduce the force required to open the dishwasher. That is, the horizontal force a user must apply to withdraw the wash chamber from the cabinet. In production the gasket 5 may be fixed to the lid 4 by mechanical means. A configuration which allows this is shown in FIG. 4. The gasket 5 is provided with an engagement member 11 extending from web 7 and this is jammed within a channel or groove 12 formed around the periphery of lid 4. Engagement member 11 may be provided with any profile commonly used in the gasket art to ensure adequate retention within the lid channel.

A second form of lid mechanism using a magnetic sealing device will be described with reference to FIGS. 5 to 8. In this embodiment the lid is floating rather than being fixed in a vertical location and is arranged to move down onto the rim of the wash chamber when the chamber is fully retracted into the cabinet.

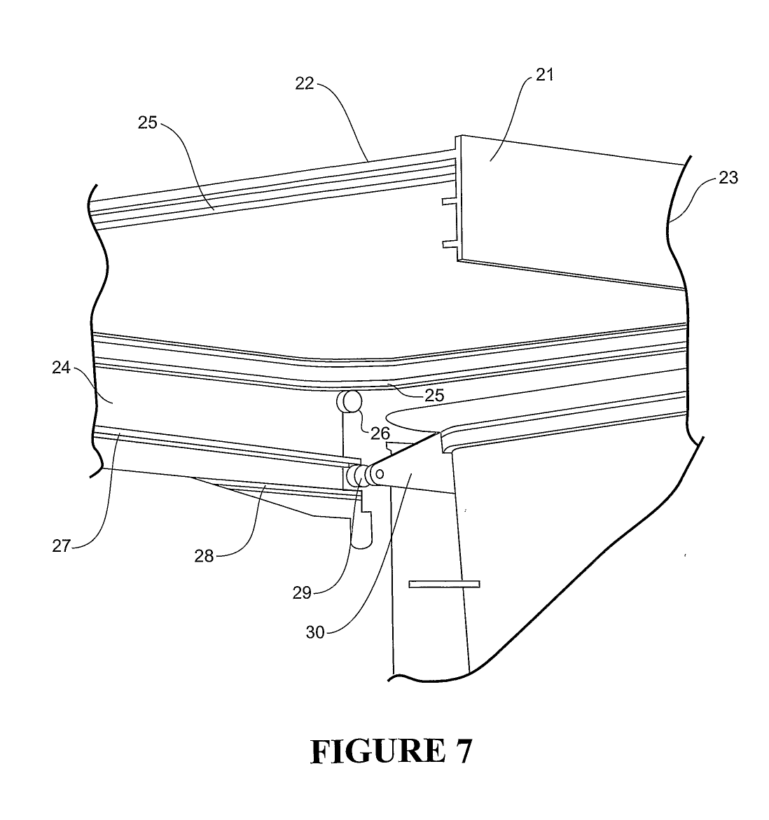

The form of floating lid 21 is best seen in FIG. 7 where wash chamber 1 is shown fully extended from the cabinet. Lid 21 comprises a horizontal planar lid section proper 22 with integral side flanges 23 and 24. Lid section 22 accommodates a magnetic sealing device 25 about its periphery and this sealing device is similar in principle to that already described with reference to FIG. 3.

In this embodiment when the chamber is fully extended as shown in FIG. 5 and FIG. 7, the front edge of the lid is held above rim 2 of the wash chamber by a pair of rollers 26 mounted at the front ends of lid flanges 23 and 24. These rollers roll along the outer edges of chamber rim 2 when the chamber is retracted and extended from the cabinet.

The interior surfaces of lid flanges 23 and 24 are provided with two camming surfaces 27 and 28. The wash chamber is provided with a pair of rollers 29 on each side of the rear face of the chamber through lugs 30. Chamber rollers 29 engage with respective cam surfaces 27 and 28 to cause the rear of the lid to be raised as the chamber is retracted.

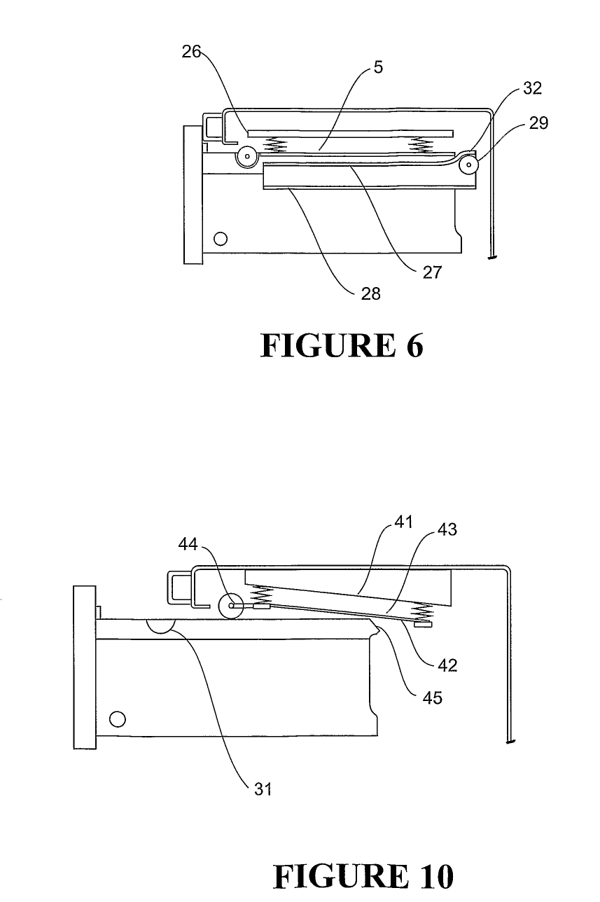

The side extremities of the chamber rim 2 which align with the tracks of rollers 26 are provided with semi-circular depressions 31 which together with the edges of rim 2 form a cam surface for rollers 26. When the chamber is almost fully retracted rollers 26 commence to enter semi-circular sections 31 to allow the front of the lid structure to move down towards the wash chamber rim. At the same time the chamber rollers 29 (see FIG. 6) enter the upward portion 32 of cam surface 27 to allow the rear of the lid to descend down onto chamber rim 2. The lid rests on the rim of the wash chamber by virtue of its own weight but sealing of the wash chamber is effected by gasket 5 snapping to the magnet provided in the chamber rim to be held closed in a watertight seal by the applied magnetic forces.

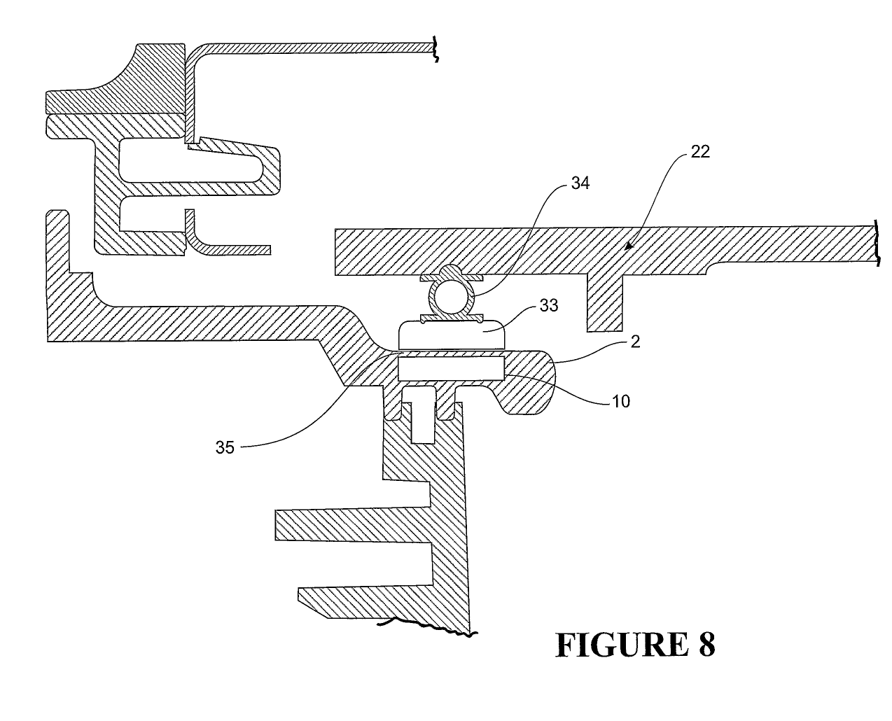

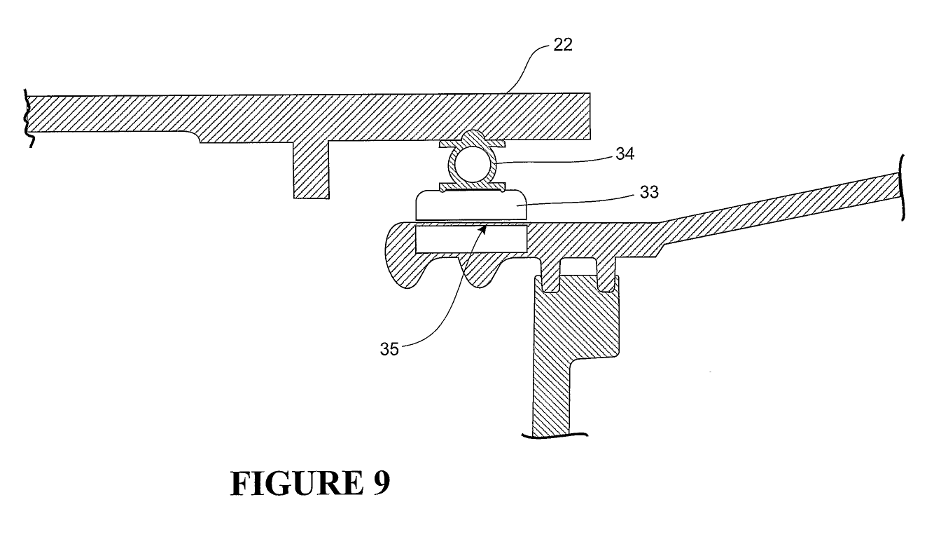

With this lid embodiment the magnetic sealing device does not require a compliant elastomeric web section since it is not necessary for the abutment portion of the seal to move horizontally in relation to the lid while still bearing against it. In this embodiment the lid moves in the vertical direction and the sealing device may be rigidly connected to the lid. A suitable implementation of magnetic seal is shown in FIG. 8. A magnet 10 is provided in rim 2 as in the previous embodiment, while an iron insert 33 is attached to the lid by a resilient extruded member 34. Iron insert 33 is still provided on its lower surface with a low friction slip coat 35, but this is simply to reduce the opening force required to pull the sliding wash chamber out from the cabinet.

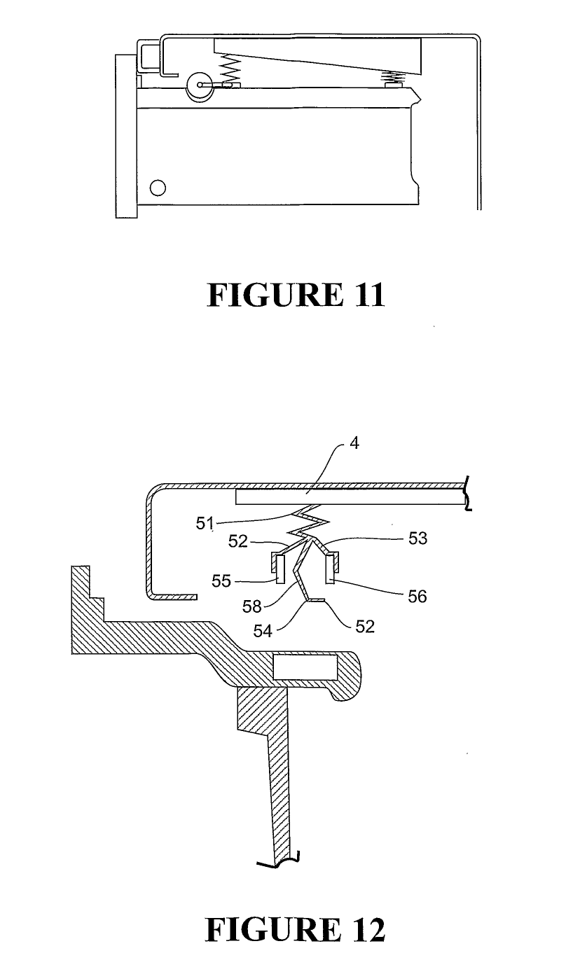

A third form of lid configuration will now be described with reference to FIGS. 10 and 11. In this embodiment the lid is fixed within the dishwasher cabinet with the lid sealing device having extended movement in the vertical direction controlled by rollers mounted either side at the front of the sealing device which run on cam surfaces provided in the rim of the wash chamber as in the second described embodiment.

Lid 41 is fix mounted in the top of the cabinet and can be inclined front to rear as shown or can be horizontal. The lid carries at its periphery a magnetic sealing device 42 similar to those described in connection with the previous embodiments of the invention. However in this case in one form (that shown in FIG. 10) magnetic material only needs to be incorporated in the sealing device along the front and rear edges of the lid because the sealing device is provided with front to rear stiffening members 43 on each side of the lid.

The sealing device thus floats from the lid in a similar manner to that described with reference to the first embodiment of the invention. However in the present embodiment a wedging action between chamber rim and lid is not used and thus the sealing device must be maintained above and clear of the chamber rim until the chamber is substantially in the washing position. To achieve this requirement two side mounted rollers 34 are attached to the lower surface of the sealing device 42. Rollers 44 run in tracks or cam surfaces provided in the outer edges of the chamber rim. One end of those cam surfaces assumes the form of a semi circle 31 into which roller 44 may drop on full retraction of the chamber. The opposite edge of the cam surfaces has a ramped lead-in portion 45 to guide the roller up onto the central portion of the cam surface upon initial insertion of the chamber into the cabinet.

In operation, as the chamber is retracted back into the cabinet, rollers 34 hold the front of the sealing device above the chamber rim and by virtue of the presence of stiffeners 43 keep the sealing device clear of the rim until the chamber is nearly fully retracted when the vertical spacing between the rear chamber rim and the rear sealing device magnet reduces sufficiently for the magnetic forces to snap the seal onto the rim. When the chamber is fully retracted the rollers 44 descend into the semi circular cam surfaces 31 allowing the front and sides of the sealing device to snap onto the chamber rim under the influence of the magnetic forces.

The surfaces of the sealing device are provided with a slip coat so that the rear edge of the sealing device may easily slide over the rim with the aid of ramped section 45. In addition to this electromagnets may be used so that until the chamber is fully retracted cause a repulsive force to exist between the chamber rim and the sealing device to ensure the sealing device remains clear of the chamber.

In practical implementations of the magnetic sealing device disclosed it may be necessary to incorporate a lip seal to ensure a fully watertight seal when dirt particles contaminate the abutting surfaces. A magnetic sealing gasket incorporating a lip seal is shown in FIG. 12. In the form shown a compliant elastomeric web section 51 is anchored about the periphery of a fixed lid 4 with its distal extremity being forked in cross section to provide three web sections 52, 53 and 54. Web sections 52 and 53 each carry respective magnetic material inserts 55 and 56. Alternatively web sections 52 and 53 may be attached to the magnetic material other than by overmoulding in which case the magnetic material is covered with a low friction slip coat.

Central web section 54 is configured to provide an abutment portion 57 at its distal edge with a central section 58 provided with resilience to urge the abutment portion 57 onto the rim of the chamber when in the closed or sealing position.

In a further embodiment where the lid is fixed vertically and magnets are contained in the gasket the lid is allowed to move horizontally for a short distance with the tub on opening so that the gasket magnets align with another set of magnets mounted in the dishwasher cabinet above the lid which provide an attraction force to break the gasket seal to the tub.

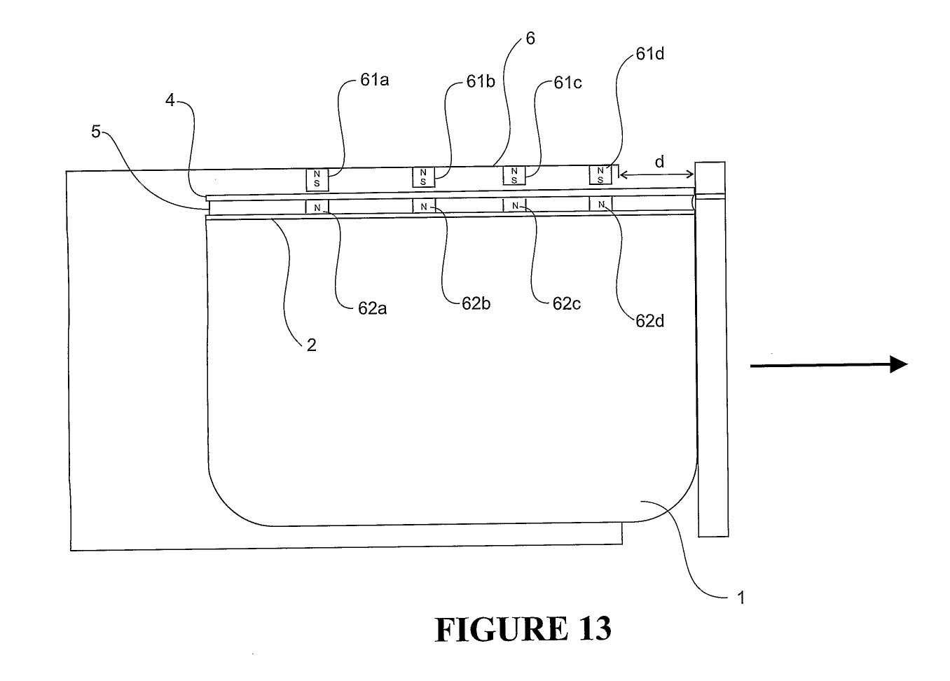

FIG. 13 shows a tub which has been withdrawn a distance “d” from the dishwasher cabinet. (Distance d has been exaggerated in FIG. 13). In this embodiment a second set of magnets 61a to 61d (only four are shown for illustrative purposes) is mounted in the cabinet chassis 6 immediately above lid 4. This set is forwardly displaced by distance d relative to the positions of the gasket magnets 62a to 62d when the tub is fully retracted within the cabinet. The chassis magnets 61 are oriented so that the polarity of the (N) poles which face the lid(s) is opposite to the polarity of the poles of the gasket magnets 62 which face the lid.

When the tub is withdrawn by d the two sets of magnets 61 and 62 align and the resultant attraction force tends to lift the gasket 5 off the tub rim 2 in opposition to the attracting force between the gasket magnets 62 and the magnetic material in the tub rim 2.

The inevitable spacing between the chassis magnets 61 and the gasket magnets 62 means the lifting force will not exceed the sealing force unless expensive powerful rare earth magnets or electromagnets are used for magnets 61. In this embodiment of the invention it is proposed that only a few of the chassis magnets be of this type. Once these magnets lift a section of the gasket from the tub rim the section of the gasket under the next ordinary magnet 61 will be moved closer to it and with the reduced spacing the stronger attraction force will overcome the sealing force exerted on that section. Once that section has in turn lifted the same effect will occur on the next adjacent gasket section. The process will ripple around the gasket to “peel” it completely off the tub rim. The tub can then be further withdrawn without resistance due to the magnetic gasket sealing forces.

1. A dishwasher having a cabinet containing one or more wash chambers wherein at least one wash chamber has an open top and slides out of said cabinet from a washing position for loading and unloading, and a closure mounted in said cabinet which closes the top of said wash chamber during the washing process,
characterised in that a flexible gasket containing a magnetic material is provided at the periphery of said closure, the edges of said wash chamber defining said open top contain a magnetic material such that when said wash chamber is in or nearly in said washing position the magnetic force between said gasket and said chamber cause said gasket to engage in a substantially water tight seal with the top of said wash chamber, and a low friction surface is provided to minimise the resistance to wash chamber sliding motion due to the frictional force between said gasket and said wash chamber edges when said gasket is engaged with said chamber edges.

2. A dishwasher according to claim 1 wherein the magnetic material provided in said gasket is a magnet and the magnetic material provided in the edges of said chamber opening is an iron containing metal.

3. A dishwasher according to claim 1 wherein the magnetic material provided in said gasket is an iron containing metal and the magnetic material provided in the edges of said chamber opening is a magnet.

4. A dishwasher according to claim 1 wherein the magnetic material provided in said gasket is a magnet and the magnetic material in the edges of said chamber is a magnet, said gasket and chamber magnets aligned so that opposite poles are adjacent.

5. A dishwasher according to claim 2 wherein said magnet is an electromagnet.

6. A dishwasher according to claim 1 wherein said closure is moveable in the vertical direction and one or more actuators are provided between said cabinet and said closure which when actuated lift said closure to thereby disengage at least a portion of said gasket from said chamber edges.

7. A dishwasher according to claim 1 wherein said gasket is moveable in the vertical direction and one or more actuators are provided between said cabinet and said gasket which when actuated lift said gasket to thereby disengage at least a portion of said gasket from said chamber edges.

8. A dishwasher according to claim 1 wherein said low friction surface is provided by forming said gasket from a low friction material.

9. A dishwasher according to claim 1 wherein said low friction surface is provided by forming said chamber edges from a low friction material.

10. A dishwasher according to claim 8 and further providing said chamber edges with a low friction surface.

11. A dishwasher according to claim 1 wherein the body of the gasket is formed from an elastomeric material and said low friction surface is provided by forming the surface which engages said chamber from a low friction material.

12. A magnetic seal for the lid and wash chamber of a dishwasher of the type wherein one wash chamber has an open top and slides out of said cabinet from a washing position for loading and unloading and a closure mounted in said cabinet which closes the top of said wash chamber during the washing process, characterised in that:
a flexible gasket including a low friction abutting surface and containing a magnetic material is provided at the periphery of said closure which when said wash chamber is in or nearly in the washing position is attracted by magnetic force to engage in a substantially water tight seal with the top of said wash chamber.

13. A dishwasher according to any one of claims 1 to 4 wherein the top side edges of the chamber which are parallel to the direction of chamber slide motion, said closure is provided with peripheral flanges and the side flanges are included complementary to the inclination of the chamber edges such that sliding said chamber from a loading position to said washing position reduces the vertical distance between the chamber top edges and said gasket.

14. (canceled)

15. A dishwasher having a cabinet containing one or more wash chambers wherein at least one wash chamber has an open top and slides out of said cabinet from a washing position for loading and unloading, and a closure mounted in said cabinet which closes the top of said wash chamber during the washing process
characterised in that a flexible gasket containing a magnetic material is provided at the periphery of said closure, the edges of said wash chamber defining said open top contain a magnetic material such that when said wash chamber is in or nearly in said washing position the magnetic force between said gasket and said chamber cause said gasket to engage in a substantially water tight seal with the top of said wash chamber, and
wherein said closure is mounted to permit a limited movement in the chamber sliding direction, and said magnetic material in said gasket is provided as a series of distributed parts, and a set of magnets are mounted in said cabinet above but forward of said distributed parts of magnetic material such that on the chamber being moved a limited distance from said washing position said closure remains sealed against said chamber and moves with it whereupon said set of magnets align with corresponding parts of magnetic material in said gasket and exert a lifting force on said gasket tending to break said seal to minimise the resistance to wash chamber sliding motion due to a friction force between said gasket and said wash chamber edges when said gasket is engaged with said chamber edges.

16. A dishwasher according to claim 3 wherein said magnet is an electromagnet.

17. A dishwasher according to claim 4 wherein said magnet is an electromagnet.

18. A dishwasher according to claim 15 wherein said magnet material provided in said gasket is a series of magnets.

19. A dishwasher according to claim 15 wherein said magnet material provided in said gasket is a series of magnets and are aligned with said second set of magnets mounted in said cabinet so that opposite poles are adjacent when said lid is sealed against said chamber.

20. A dishwasher according to any one of claims 15 to 19 wherein said magnets are electromagnets.
